(19) United States
(12) Patent Application Publication
(10) Pub. No.: US 2001/0038880 A1
(43) Pub. Date: Nov. 8, 2001

(54) Method of coating carbon inside cathode ray tube funnels and an apparatus used therefor

(76) Inventors: Takashi Mukuno, Tokyo (JP); Yoshimitsu Kato, Kanagawa (JP); Takenobu Kawai, Gifu (JP); Syouichi Hamase, Gifu (JP)

Correspondence Address: COOPER & DUNHAM LLP, 1185 Avenue of the Americas, New York, NY, 10036, US

(21) Appl. No.: 09/803,865

(22) Filed: Mar. 12, 2001

(30) Foreign Application Priority Data
Mar. 15, 2000 (JP) P2000-072061

(51) Int. Cl. B05D 5/12; B05D 5/06; B05D 1/02

(52) U.S. Cl. 427/64; 427/68; 427/162; 427/421

(57) ABSTRACT

A method and an apparatus for coating interior carbon on the inner surface of cathode ray tube funnels by the flow coating process, being capable of coating the interior carbon so as to avoid adhesion thereof onto the projected portion of the anode button, and so as to ensure electrical connection between the interior carbon and the anode button will be provided. In the method, the air is spot-blown around the anode button provided inside the funnel at least when the interior carbon injected onto the inner surface of the funnel flows down to reach such anode button, to thereby prevent the interior carbon from adhering to the projected portion of such anode button.

### BACKGROUND OF THE INVENTION

1. Field of the Invention

The present invention relates to a method of coating carbon inside cathode ray tube funnels, by which interior carbon is coated on the inner surface of funnels of cathode ray tubes (CRTs) which are widely used in a television receiver, a computer display and monitor devices for various office automation devices; and an apparatus used for such coating.

2. Description of the Related Art

A cathode ray tube is generally composed of, as shown in FIG. 5, a panel portion 21, a funnel 22 and a neck portion 23. The panel portion 21 is provided with a fluorescent plane 24 and an aperture grill 25 as a color selection mechanism; the funnel 22 with an interior carbon 26 as an inner conductive film and an anode button 27 for supplying a high voltage; and the neck portion 23 with an electron gun 28.

The interior carbon 26 provided as an inner conductive film on the inner surface of the funnel 22 is formed by a variety of coating methods such as flow coating, spray coating or coating with a sponge or brush.

The funnel 22 has the anode button 27 provided on the inner surface thereof, which has to be contacted with the interior carbon 26 and thus electrically connected therewith.

Beside such requirement for electrical connection with the interior carbon 26, the anode button 27 is sometimes expected to hold a getter spring 29, as shown in FIG. 7, which is provided to support a getter for ensuring sufficient degree of vacuum within the tube. In such cases, the getter spring 29 will be attached to a projected portion 27a of the anode button 27.

If the interior carbon 26 adheres also on the projected portion 27a of the anode button 27, attachment by engagement of the getter spring 29 to such projected portion 27a will be very likely to cause scaling off of such interior carbon 26, which will remain as dust within the cathode ray tube to thereby undesirably induce in-tube discharge and degrade reliability and quality of the product.

It has thus been required, as shown in FIG. 8, for the coating to avoid adhesion of the interior carbon 26 within an area W around the projected portion 27a.

In the spray coating process, such avoidance of the adhesion of the interior carbon 26 onto the projected portion 27a of the anode button 27 can readily be accomplished by covering such projected portion 27a with a cap, and remove such cap after the spray coating is completed.

In the coating using a sponge or brush, such avoidance of the carbon adhesion onto the projected portion 27a can be accomplished by careful coating by a robot or a human worker.

Such coating processes are, however, unsatisfactory in terms of difficulty in achieving uniform adhesion strength or thickness of the interior carbon 26 formed as an interior conductive film, and in ensuring high quality thereof.

Thus the flow coating process is generally employed in the coating of the interior carbon 26.

The flow coating process is effected by vertically setting the funnel 22 as shown in FIG. 6, injecting carbon 31 from a carbon injection nozzle 30 at a position 10 mm down from the upper edge of the funnel 22, moving the carbon injection nozzle 30 along the inner periphery of the funnel 22, and collecting the effluent carbon 31 from the neck portion 23. A portion of the carbon 31 adhered on the funnel 22 is dried with a heater to be remained as an interior carbon 26, and a portion of the unnecessary carbon 31 adhered within the neck portion 23 is washed off with water and a brush.

It was, however, not so easy in the flow coating process to coat the carbon 31 so as to avoid adhesion thereof to the projected portion 27a of the anode button 27.

Since the carbon 31 is generally injected from the top so as to fall downward in the flow coating process, the projected portion 27a of the anode button 27 once trapped in the flow of the carbon 31 will inevitably catch the carbon 31. On the contrary, reducing the flow rate of the carbon 31 so as to avoid the adhesion will cause white spot due to partial omission of the carbon 31.

The flow coating process based on such down-flow of carbon 31 is not agreeable, by the nature thereof, with control through careful coating, and even capping on the projected portion 27a will cause creeping up and adhesion of the carbon 31 to such projected portion 27a. There has thus been a strong need for a simple means for solving such problems.

### SUMMARY OF THE INVENTION

To solve the foregoing problem, it is therefore an object of the present invention to provide a method and an apparatus for coating interior carbon on an inner surface of cathode ray tube funnels by the flow coating process, being capable of coating the interior carbon so as to avoid adhesion of the interior carbon onto the projected portion of the anode button, and so as to ensure electrical connection between the interior carbon and the anode button.

It is another object of the present invention is to provide a generalized method and an apparatus for coating interior carbon on the inner surface of cathode ray tube funnels by the flow coating process, being capable of being readily adopted to any types of funnels having the interior carbon preliminarily and partially coated around the cathode button or those having no preliminary carbon coating.

To solve the foregoing problem, a method of coating interior carbon inside a cathode ray tube funnel according to an aspect of the present invention is a method of coating the interior carbon on the inner surface of a cathode ray tube funnel based on the flow coating process, and is characterized in that the air is spot-blown around an anode button provided inside the funnel at least when the interior carbon injected onto the inner surface of the funnel flows to reach the anode button, to thereby prevent the interior carbon from adhering to a projected portion of such anode button. According to the method, the interior carbon flowing down toward the anode button can round about the button by the air previously spot-blown around the anode button, so that adhesion of the interior carbon onto the projected portion of the anode button will surely be avoided.

This method is applicable regardless of presence or absence of previous coating of the interior carbon around the anode button.

In the foregoing method for coating interior carbon inside a cathode ray tube funnel according to another aspect of the present invention, the spot-blowing of the air is interrupted after a nozzle for injecting the interior carbon onto the inner surface of the funnel passes over the anode button. Such interruption of the air blow after the interior carbon injection nozzle passed over the anode button will allow the interior carbon remaining on the upper portion of the funnel to slowly flow down the inner surface, so that the interior carbon will not adhere on the projected portion of the anode button but only to a lower portion thereof, to thereby ensure electrical connection.

This method is in particular effective for the funnel having no preliminary coating of the interior carbon around the anode button.

In the foregoing method for coating interior carbon inside a cathode ray tube funnel according to still another aspect of the present invention, the spot-blowing of the air is effected toward a position above the projected portion of the anode button and slightly ahead of the nozzle for injecting the interior carbon along the moving direction thereof. Such spot air blow toward the position above the projected portion of the anode button and slightly ahead of the nozzle for injecting the interior carbon along the moving direction thereof will allow the interior carbon being injected and flowing down to round about the anode button, so that the interior carbon will not adhere on the projected portion of the anode button but only to a lower portion thereof.

To solve the foregoing problem, an apparatus for coating interior carbon inside a cathode ray tube funnel of the present invention is an apparatus for coating interior carbon on the inner surface of a cathode ray tube funnel based on the flow coating process, which comprises a spot air nozzle for spot-blowing the air provided at a position not causative of interference with a nozzle for injecting the interior carbon so as to be opposed to an anode button provided inside the funnel. Such spot air blow toward a predetermined position on the inner surface of the funnel from the spot air nozzle will allow the interior carbon being injected and flowing down to round about the anode button, so that such interior carbon will not adhere on the projected portion of the anode button but will be uniformly coated over the entire inner surface of the funnel.

In the foregoing apparatus for coating interior carbon inside a cathode ray tube funnel according to another aspect of the present invention, the spot air nozzle is composed of a perforated nozzle having a plurality of fine holes. Providing a plurality of fine holes in a properly arranged manner will properly control the interior carbon so as to flow down in an optimum manner while rounding about the projected portion of the anode button.

In the foregoing apparatus for coating interior carbon inside a cathode ray tube funnel according to another aspect of the present invention, the spot air nozzle is set so as to adjust an angle of air blow within a range from 50° to 80° away from the inner surface of the funnel. Setting the angle of air blow within a range from 50° to 80° will successfully avoid splash or omission of the interior carbon, and allow uniform coating of the interior carbon on the inner surface of the funnel.

As is clear from the above, according to a method and an apparatus for coating carbon inside cathode ray tube funnels of the present invention, the interior carbon will certainly be coated only to the lower portion of the anode button without adhering to the projected portion thereof.

This ensures the anode button and the interior carbon to be electrically connected with each other, to thereby allow the funnel to be supplied with a high voltage. Since the projected portion no more has the interior carbon adhered thereon, scaling off of such adhered interior carbon and successive accumulation thereof as a dust within the cathode ray tube should not occur even when a getter spring is to be attached thereto, so that troubles such as in-tube discharge due to the accumulated dust cannot be induced, which results in an improved quality of the cathode ray tube.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a perspective view showing an apparatus for coating carbon inside cathode ray tube funnels according to an embodiment of the present invention;

FIGS. 2A and 2B are a front view and a side view, respectively, of a constitution of a spot air nozzle;

FIG. 3 is a side view showing a state of spot air blowing to an upper portion of an anode button;

FIG. 4 is a front view showing a state of carbon flow under spot air blow;

FIG. 5 is a perspective view showing a constitution of a cathode ray tube;

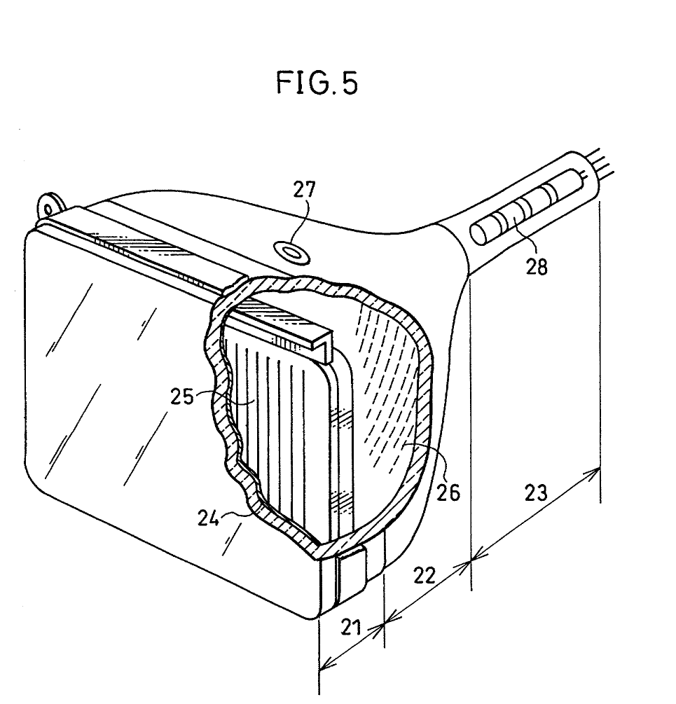

FIG. 6 is a perspective view showing a conventional method of coating carbon inside cathode ray tube funnels based on the flow coating process;

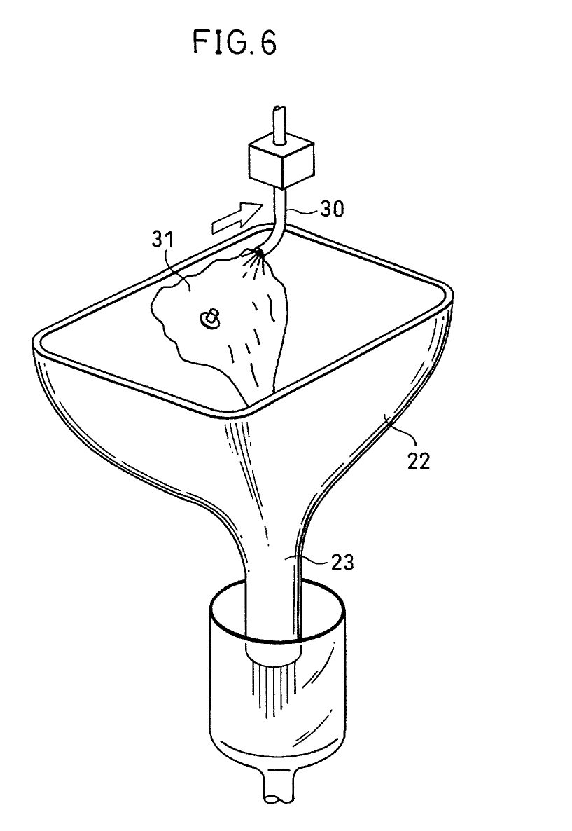

FIG. 7 is a perspective view showing a state of attaching a getter spring to a projected portion of an anode button; and

FIG. 8 is a sectional view showing a constitution of an anode button.

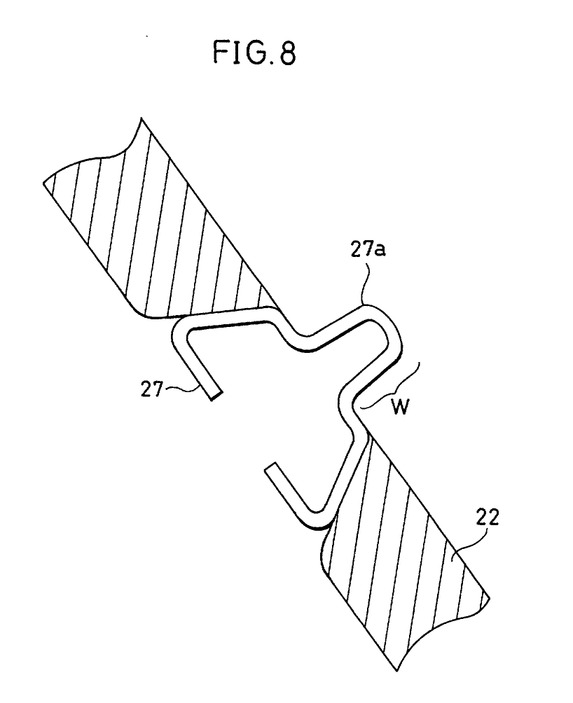

### DESCRIPTION OF THE PREFERRED EMBODIMENT

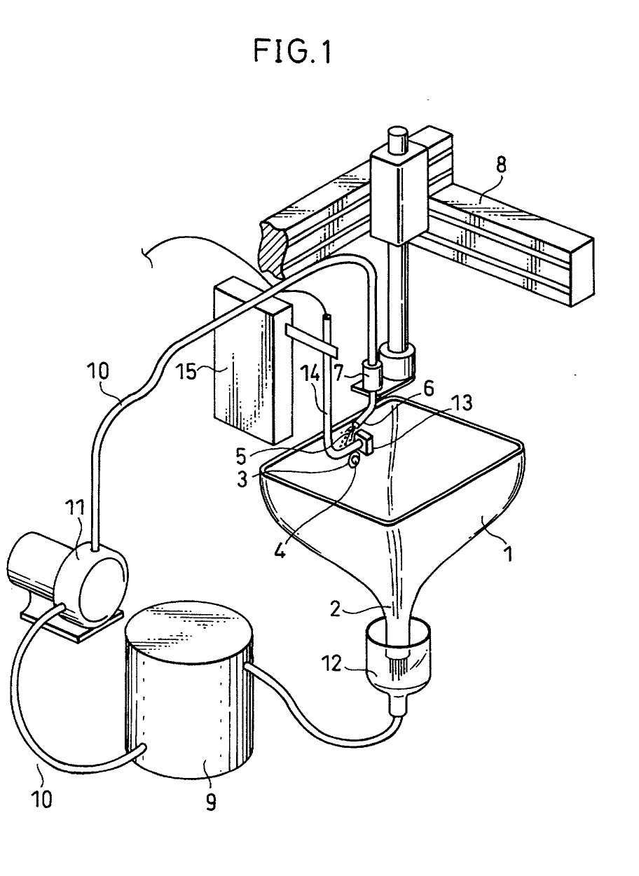

Preferred embodiments of the present invention will be explained hereinafter referring to FIGS. 1 to 4.

In FIG. 1, reference numerals 1 and 2 denote a funnel and a neck portion, respectively, of a cathode ray tube, both of which are conveyed into an interior carbon coating apparatus while being supported by a cone support, which is an accessory of a carrier palette, so as to direct the neck portion 2 downward.

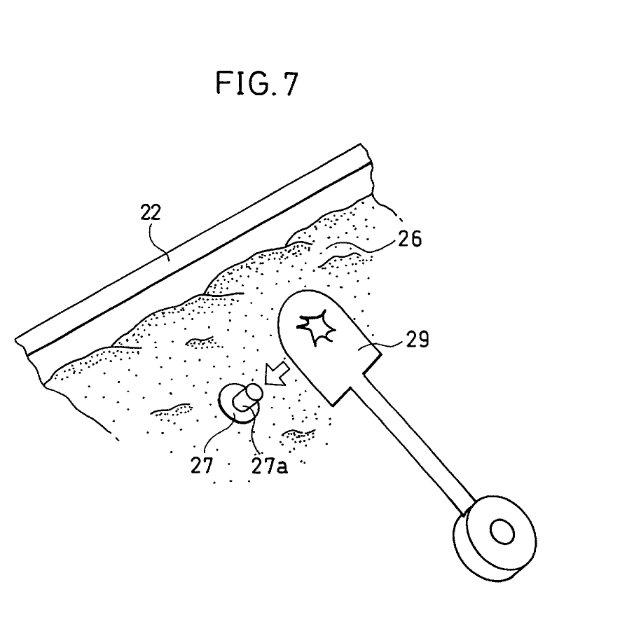

Reference numeral 3 denotes an anode button provided inside the funnel 1, to which a projected portion 4 is provided so as to project out from the inner wall of the funnel 1 for a convenience of attaching a getter spring 29 (see FIG. 7).

The interior carbon coating apparatus comprises a carbon injection nozzle 6 which injects interior carbon 5 to a position on the inner surface of the funnel portion 1 approx. 10 mm down from the upper edge thereof, a carbon regulating valve 7 for regulating the injection of the interior carbon 5, a multi-axis robot arm 8 for moving these components, a carbon tank 9 for storing the interior carbon 5, a carbon pump 11 for supplying the interior carbon 5 stored in the carbon tank 9 through a hose 10 to the carbon regulating valve 7 and the carbon injection nozzle 6, a carbon recovery tank 12 for collecting effluent interior carbon 5 from the lower neck portion 2 after flowing down on the inner surface of the funnel portion 1, and so on.

The apparatus further comprises a spot air nozzle 13 for spot-blowing the air while being supported to be movable upward and downward via an air pipe 14 by a vertical moving mechanism 15, where the spot air nozzle 13 being provided at a position not causative of interference with the carbon injection nozzle 6 which travels with the aid of the multi-axis robot arm 8 along the upper periphery of the funnel 1 while injecting the interior carbon 5, and at a position opposed to an anode button 3 provided inside the funnel 1.

The spot air nozzle 13 is attached on the end of the L-bent air pipe 14, and is composed of a perforated nozzle having 3 to 10 fine holes 13a with a diameter of approx. 0.5 to 0.8 mm.

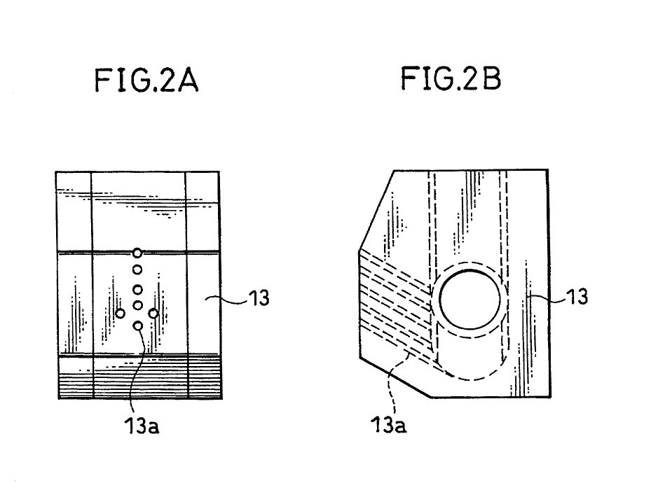

The fine holes 13a are aligned, as shown in FIG. 2A, so that several numbers of which come vertically in line, and several numbers of which come horizontally in line at a lower position, so as to ensure an optimally-controlled spot air blow which forces the flow of the interior carbon 5, injected from the carbon injection nozzle 6 and flows down from the upper edge portion of the funnel 1, to round about the projected portion 4 of the anode button 3 as if the interior carbon 5 avoids the projected portion 4.

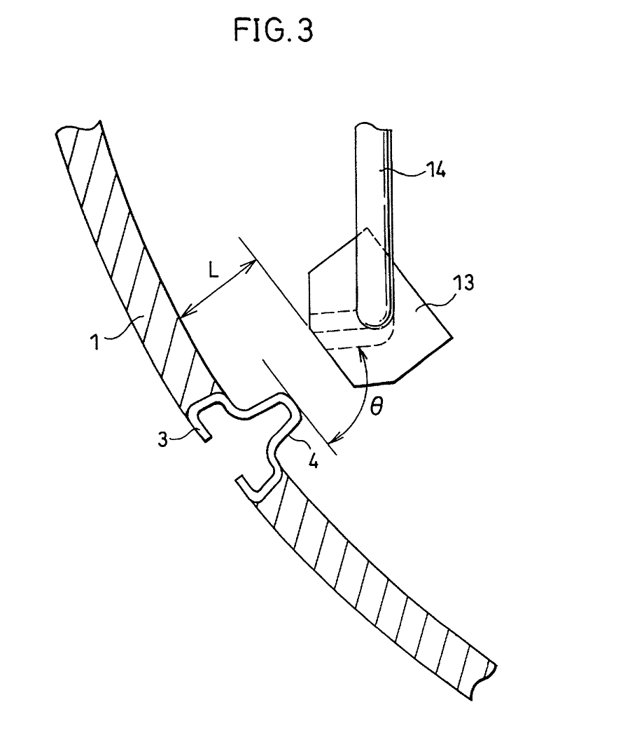

The spot air nozzle 13 is positioned distant by “L” of 40 to 50 mm from the inner surface of the funnel 1 as shown in FIG. 3, so as to adjust an angle θ of air blow within a range from 50° to 80°. Here, it is sufficient for the pressure of the air blown thereto to be about 0.01 to 0.02 MPa.

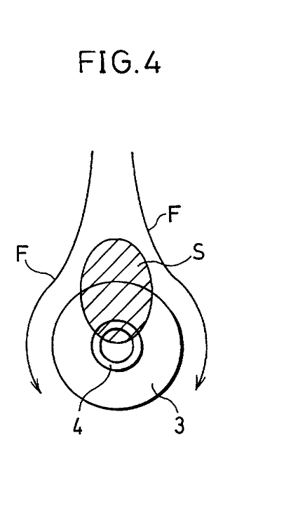

Coating of the interior carbon 5 on the inner surface of the funnel 1 using the above-mentioned coating apparatus is effected first by descending the spot air nozzle 13 with the aid of the vertical moving apparatus 15, and setting the spot air nozzle 13 at a position opposed to the anode button 3 as shown in FIG. 3, and allowing the spot air blow toward an area S which is located slightly upward the anode button 3 and in front of the carbon injection nozzle 6 along the moving direction thereof as shown in FIG. 4.

After the carbon injection nozzle 6 is set ahead of the anode button 3, the carbon control valve 7 is opened, and the carbon injection nozzle 6 is moved along the upper periphery of the funnel 1 while discharging the interior carbon 5, to thereby coat the interior carbon on the inner surface of the funnel 1.

The interior carbon 5, discharged from the carbon injection nozzle 6 onto the inner surface of the funnel 1, is certainly prevented from being caught by the projected portion 4 of the anode button 3 by virtue of the spot air blow toward the area S around thereof shown in FIG. 4 effected at least when such interior carbon 5 flows down to reach the anode button 3.

Such spot air blowing during the interior carbon injection toward the area S slightly upward the anode button 3 can effectively direct the down-flow of the interior carbon 5 to round about the anode button 3 as indicated by an arrow F in FIG. 4, to thereby ensure uniform coating of the interior carbon 5 on the inner surface of the funnel 1 without causing adhesion thereof to the projected portion 4 of the anode button 3.

The anode button 3 now has to be electrically connected with the interior carbon 5 at the lower portion thereof although the projected portion 4 thereof should not have the interior carbon 5 adhered thereon.

Hence, there are two possible methods for coating the interior carbon 5; where one method is such that the funnel 1 is pre-coated with the interior carbon 5 only around the anode button 3 and then subjected to the flow coating; and the other method is such that the funnel 1 having no pre-coated interior carbon 5 is subjected to flow the flow coating.

In the former method, only a consideration for preventing the adhesion of the interior carbon 5 mainly to the projected portion 4 will suffice, since the interior carbon 5 is pre-coated around the anode button 3 to ensure the electrical connection. In such case, only a spot air blow effected by setting the spot air nozzle 13 within the requirements described in the above will suffice, so that no excessive consideration is required for defining an air pressure, a blowing area, a timing for interrupting the air blow and the like to avoid splashing or omission of the carbon. In particular with regard to the air blow, the blowing at least when the interior carbon 5 injected and flows down to reach the anode button 3 will suffice, and it is sometimes allowable to sustain the air blow without interruption even after the flow of the interior carbon 5 went by.

In the latter method with a non pre-coated funnel 1, too strong air blow for interrupting the flow of the interior carbon 5 may undesirably cause carbon omission around the anode button 3, to thereby inhibit electrical connection between the lower portion of such anode button 3 and the interior carbon 5.

It is therefore important to define an air pressure, a blowing area and the shape thereof, a timing for interrupting the air blow and the like to ensure electrical connection and to avoid adhesion of the interior carbon 5 to the projected portion 4.

Empirically saying, while depending on set conditions of the spot air nozzle 13 and viscosity of the carbon to be injected, the spot air blow can be activated in an elongated area S upward the projected portion 4 of the anode button 3 and slightly ahead of the carbon injection nozzle 6 along the moving direction thereof, and can be inactivated 0.5 to 1.0 seconds after the carbon injection nozzle 6 passed over the anode button 3. According to such method, a volume flow of the interior carbon 5 immediately after the injection will be directed by the spot air blow so as not to spread excessively to thereby prevent adhesion of the interior carbon 5 to the projected portion 4 of the anode button 3, and a slow down-flow of the residual interior carbon 5 comes down from the upper portion of the funnel 1 after the cessation of the spot air blow can spread over the lower portion of the anode button 3 to thereby complete the carbon coating so as to ensure the electrical connection.

Hence according to the foregoing embodiment, the interior carbon 5 can certainly be coated while preventing the interior carbon 5 from adhering to the projected portion 4 of the anode button 3 and from splashing and being omitted, which can be accomplished irrespective of whether the funnel 1 is partially pre-coated with the interior carbon 5 in an area around the anode button 3 or not.

The coating apparatus of the present invention can readily be manufactured or improved only by adding the spot air nozzle 13 to the conventional apparatus.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A method of coating interior carbon inside a cathode ray tube funnel in accordance with the flow coating process, comprising the steps of:
spot-blowing the air around an anode button provided inside said funnel at least when said interior carbon injected through a carbon injection nozzle onto an inner surface of said funnel flows down to reach said anode button; and
preventing said interior carbon from adhering to a projected portion of said anode button.

2. The method of coating interior carbon inside a cathode ray tube funnel as claimed in claim 1, wherein the spot-blowing of the air is interrupted after said carbon injection nozzle for injecting said interior carbon onto the inner surface of said funnel passes over said anode button.

3. The method of coating interior carbon inside a cathode ray tube funnel as claimed in any one of claim 1 and claim 2, wherein said spot-blowing of the air is effected toward a position above the projected portion of said anode button and slightly ahead of said carbon injection nozzle for injecting said interior carbon along the moving direction thereof.

4. An apparatus for coating interior carbon inside a cathode ray tube funnel in accordance with the flow coating process, which comprises a spot air nozzle for spot-blowing the air provided at a position not causative of interference with a nozzle for injecting said interior carbon so as to be opposed to an anode button provided inside said funnel.

5. The apparatus for coating interior carbon inside a cathode ray tube funnel as claimed in claim 4, wherein said spot air nozzle is composed of a perforated nozzle having a plurality of fine holes.

6. The apparatus for coating interior carbon inside a cathode ray tube funnel as claimed in any one of claim 4 and claim 5, wherein said spot air nozzle is set so as to adjust an angle of air blow within a range from 50° to 80° away from an inner surface of said funnel.
